(19) United States
(12) Patent Application Publication
(10) Pub. No.: US 2002/0058137 A1
(43) Pub. Date: May 16, 2002

(54) Dielectric spacing layer

(76) Inventor: Leif Roland Bergstedt, Sjomarken (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/986,788

(22) Filed: Nov. 9, 2001

(30) Foreign Application Priority Data
Nov. 10, 2000 (SE) 0004125-1

(51) Int. Cl. B32B 5/16

(52) U.S. Cl. 428/323; 428/416

(57) ABSTRACT

The present invention relates to a distance retaining dielectric material applied between layers of a conductive material, so as to enable the distance between said layers to be minimized to a given permitted minimum distance. This is achieved by providing the dielectric material, e.g. a glue film, with a low concentration of non-conductive particles that hold the layers at a minimum distance apart corresponding to the diameter of the particles.

### FIELD OF INVENTION

The present invention relates to a dielectric spacing layer applied between a layer of conductive material so as to maintain a given spacing between the layers.

### DESCRIPTION OF THE BACKGROUND ART

So-called printed circuit boards or component carriers that can be used beneficially for implementing different circuitries are at present used in practically all modern electronic equipment. These printed circuit boards afford many advantages. Among other things, they are simple to manufacture, they can be disposed in a distinct and space-saving fashion in the equipment, and can be readily replaced or exchanged. A printed circuit board of this nature is comprised of a carrying basic part on which a dielectric material is applied. The components with which the function of the board is achieved are interconnected by thin conductors that extend in or on the dielectric layer.

Present-day trends, for instance in mobile telephony, are directed towards the development of ever smaller system solutions and also towards higher transmission frequencies, which also places an increasingly higher demand on the design and dimensioning of printed circuit boards. For instance, higher the transmission frequencies lead to the requirement of smaller electric components, e.g. capacitors, that have very small surface areas. This also leads to densely packed designs with short distances between the conductors, for example on a printed circuit board, therewith increasing the danger of short circuiting between conductive layers. Short circuits are caused by a live conductor being in such close contact with another conductor as to form a high electric field, i.e. it generates in the interspace a sufficient number of charged particles to contribute towards the creation of a conductive channel between the conductors. The field strength Eₘₐₓ(d) at which such a short circuit occurs depends partly on the distance d between the conductors and also on the nature of the material between the conductors, more specifically on the possible energy density of the material, this density giving a measurement relating to the amount of energy that the material is able to store.

This energy density w is essentially proportional to the field strength E and the materialspecific dielectric index εr:

w˜εr·E(d)²

Because a printed circuit board design must be able to prevent undesirable short circuits from occurring between the conductors, it is decisive that these conductors are kept at a given minimum distance apart, which, as shown above, is governed by the nature of the dielectric material between the conductors, among other things.

One known technique of obtaining effective insulation against short circuits between conducting layers involves the use of a layer of a dielectric glue that includes a woven fibreglass reinforcement. However, this layer needs to have a given minimum thickness, in the order of some 10 μm, in order to achieve effective insulation.

Another known technique is described in WO 91/18491 A1. In the manufacture of a printed circuit board that comprises a plurality of mutually sequential layers, the layers are impregnated with a curable resin gum. The gum is then heated, by delivering energy to limited areas so as to glue the layers together in these areas. The resultant structure is then laminated by applying heat and high pressure, such as to create the printed circuit board (c.f. the abstract, page 5).

### SUMMARY OF THE INVENTION

The problem addressed by the invention relates to the known fact that the risk of short circuiting between two electrically conductive layers increases when the thickness of the dielectric material located between said layers is beneath a given minimum value.

A first object of the present invention is to provide a material that can be used to produce very thin dielectric layers.

Another object of the invention is to provide a dielectric material that can be used to minimise the thickness of a dielectric layer between two electric conductors to a given permitted minimum distance, in a controlled manner.

The invention is based on the concept of providing a material, e.g. a glue film, to be used as a dielectric between two conductive layers with a low concentration of non-conductive particles. These particles prevent short circuiting between the conductive layers, by keeping the layers at a minimum distance apart, this distance corresponding to the diameter of the particles between the layers.

The characteristic features of the inventive dielectric material will be more apparent from the accompanying claims.

One advantage afforded by the inventive dielectric material is that a thin dielectric layer can be provided between two conductors with the conductors spaced at a given minimum distance apart that will not enhance the risk of short circuiting between said conductors.

Another advantage is that component carriers, for instance a printed circuit board, can be given a thinner design.

Still another advantage afforded by the invention is that component carriers can be given thin, sequentially constructive layers.

Yet another advantage afforded by the invention is that the inventive dielectric material facilitates the construction of a buried capacitor, for instance.

A commercially acceptable production of thin dielectric layers is one advantage afforded by the inventive method.

### BRIEF DESCRIPTION OF THE DRAWINGS

The invention will now be described in more detail with reference to preferred exemplifying embodiments thereof and also with reference to the accompanying drawings.

FIG. 1 illustrates a first embodiment of the invention comprising two conductive layers and an intermediate dielectric.

FIGS. 2a-2d illustrate the method steps for spacing two conductive layers at a given minimum distance apart with the aid of the inventive dielectric spacing material.

FIGS. 3a-3b illustrate respectively the use of the inventive dielectric material for producing a buried capacitor.

### DESCRIPTION OF PREFERRED EMBODIMENTS

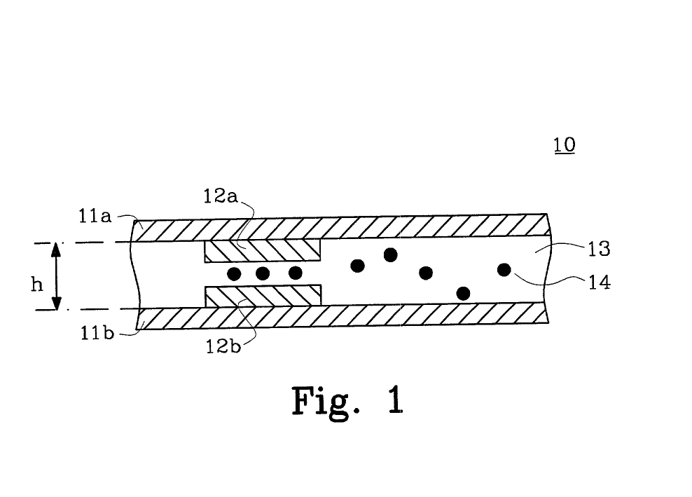

FIG. 1 illustrates part of a structure 10 that includes two layers 11a, 11b and an intermediate layer 13, this latter layer being comprised of the inventive dielectric material. The invention is based on the concept of including in said dielectric material a low concentration of non-conductive particles 14, primarily with the object of being able to control the thickness of the dielectric layer comprised of said material so that the layer height h can be reduced to a given absolute minimum distance that cannot be surpassed. Because the particles 14 are comprised of a non-conductive material, short circuits between two conductors 12a, 12b will be effectively prevented. Thus, the dielectric material has a distance holding effect, for example when mounting on a carrier two conductive layers and an intermediate dielectric. This enables the invention to be applied beneficially when mounting components on a printed circuit board or for building-up sequential layers on a printed circuit board in which space-saving is a high requirement, for example. Another area of use resides in the manufacture of small-scale components, such as capacitors.

The properties of the inventive dielectric material can be modified in accordance with the contemplated area of use, through the choice of the dielectric material on the one hand and by varying the properties of the particles with which the material is doped on the other hand.

The minimum possible thickness value of the dielectric layer is determined essentially by the size of the particles. Depending on particle size, it is possible to obtain between the conductors 12a, 12b controlled distances in the order of magnitude of only some micrometers. Particle sizes in the order of magnitude of 5-20 μm are normally used. A lower limit with respect to particle size is governed by the smallest distance allowed by the dielectric material without the occurrence of a short circuit.

As will be described later, the inventive dielectric material is normally used as a dielectric between two conductive layers, which will allow the layers to be pressed together to a given minimum distance apart. However, this implies that a pressure is exerted over the whole of the layer surface. A conceivable modification is one in which the particle shape in different alternative embodiments of the inventive dielectric material is modified to achieve beneficial distribution of pressure on the particles. Instead of being spherical, as in the case of the FIG. 1 illustration, the particles may have a thread-like form, for instance consist of fibreglass particles, or flakes.

A further parameter is the particle concentration in the dielectric material. Generally speaking, the particle concentration shall be low, for instance ranging from 5%-15% inclusive, meaning that said particles comprised 5%-15% of the dielectric material. A bottom limit of a concentration range is apparent from the fact that there must be present in the dielectric material a sufficient number of particles to ensure the probability that the number of particles present between the conductors will suffice to exceed a given minimum value. On the other hand, the particle concentration may not exceed a maximum value, in order to avoid stacking of the particles. Particle stacking would prevent a minimum distance corresponding to particle diameter or particle thickness from being achieved. When using a dielectric glue film, it is also important that the concentration of non-conductive particles is not high enough to considerably impair the adhesive properties of the glue.

Also influential is the choice of material from which the particles are made in connection with the dielectric material in which these particles are embedded. An appropriate dielectric material has a high viscosity, for example the consistency of a soft paste or of a glue film having an adhesive effect. A particularly beneficial material is one which can be applied in a soft state at a given laminating temperature and which then hardens or cures at normal room temperature. The use of such a material has the benefit of enabling two sequential layers that shall be held apart be mounted in a firm connection. However, an important criterion is that the properties of the material, e.g. with respect to adhesiveness or viscosity, will not change essentially at temperatures that occur on, e.g., a printed circuit board in operation. Appropriate materials that have an adhesive effect are, e.g., thermosetting resins, such as epoxy resins. Other dielectric materials can alternatively be used, such as thermoplastics.

When using a dielectric glue film that hardens after the manufacturing process to produce, for instance, a printed circuit board that has a firm structure comprised of sequentially built-up layers with intermediate dielectric material, a thin dielectric layer is obtained by heating the dielectric material to a given temperature. This enables an object to be pressed into or to sink into the dielectric layer to a depth at which further penetration of the object is prevented by the particles, wherewith the dielectric layer obtains a given minimum thickness that corresponds to the diameter of the particles. However, a decisive factor in ensuring that the layer thickness does not fall beneath said minimum thickness is that the particle material has a higher temperature resistance than the dielectric material, so that the particles will not be deformed at the laminating temperature while applying typical pressure conditions when compressing the layers. The laminating temperature must be considerably higher than those temperatures that occur, e.g., on a printed circuit board in operation. A suitable particle material is, for instance, ceramic powder or an appropriate plastic-based material. Typical values of the dielectric index εr of the particles may lie in a range of 3-9.

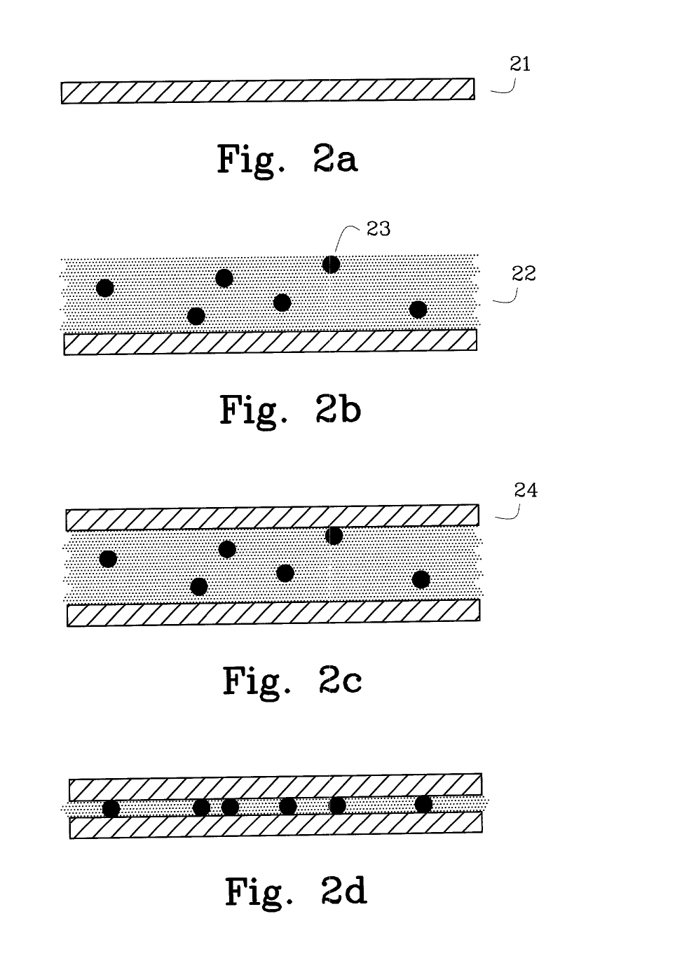

FIG. 2 illustrates the method steps of spacing two conductive layers 21, 24 apart through a given minimum distance with the aid of the inventive distance-maintaining dielectric material. The conductive layers 21, 24 may, for example, be an earth plane and an electronic component or conductor on a printed circuit board, or two capacitor surfaces. As shown in FIG. 2b, a layer of the inventive dielectric material 22 is applied to a first layer 21, shown in FIG. 2a. The material is doped with non-conductive particles 23 to a given concentration, as described above, in order to obtain a dielectric that has the properties desired. In a following step, FIG. 2c, a second layer 24 is applied to the dielectric material 22. This second layer 24 is either pressed against the first layer 21 or allowed to sink into the dielectric material 22 under its own weight. The particles 23 are therewith also pressed together in the dielectric material, into a continually decreasing space. These particles prevent the distance between the two layers 21, 24 from surpassing a given minimum value corresponding to the diameters of the particles, as shown in FIG. 2d.

The dielectric material, for example in the form of a dielectric glue film which is doped with non-conductive particles to a low concentration, may be used beneficially to create a space-saving dielectric layer in a simple fashion. The inventive material advantageously facilitates mounting of electronic components, e.g., onto a printed circuit board, in those instances when, for reasons of manufacture, it may be difficult to place a conductive layer on a dielectric without therewith surpassing a given minimum value with respect to the thickness of the dielectric layer.

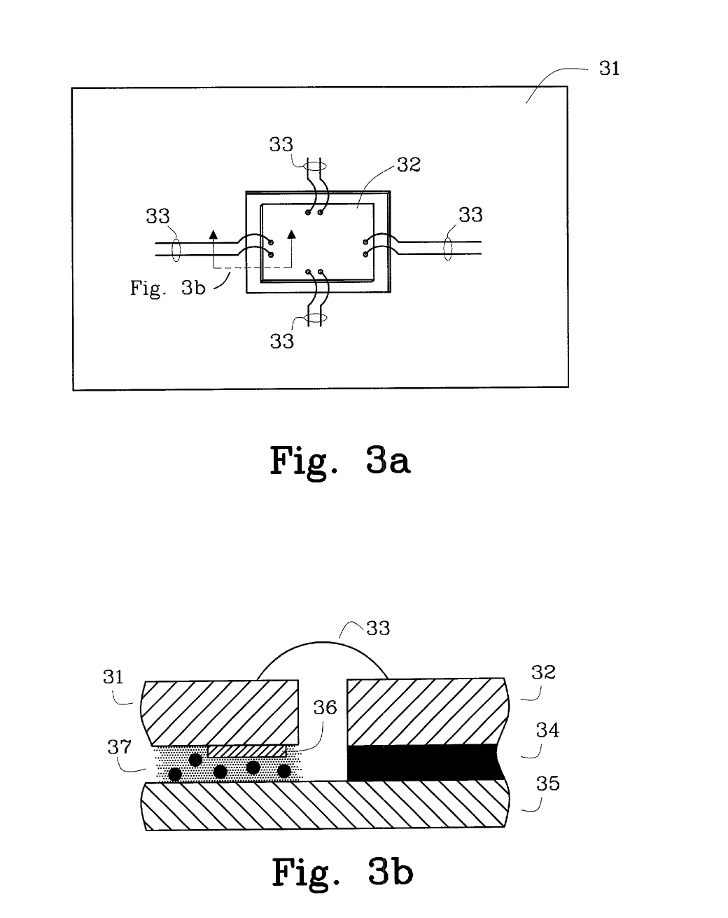

There is shown in FIG. 3 an advantageous use of the inventive dielectric material when mounting an electronic chip 32 on a printed circuit board 31. In the case of the illustrated example, the chip 32 is mounted on a base element 34 in a suitable cavity on the board 31. The chip 32 is intended to carry out certain functions that are controlled by microwave signals applied from without, through the medium of contact conductors 33. In this case, it may be important to effectively de-couple undesired signals leaving or entering the chip 32. In the illustrated case, this is achieved with the aid of a decoupling filter disposed between the chip 32 and the remainder of the board 31. Such a filter is used to de-couple incoming interference signals and biasing signals to the chip 32, on the one hand, and to prevent signals on the chip 32 from leaking out on the control signals 33, on the other hand. This filter function can be implemented in a space-saving fashion through the medium of a so-called buried capacitor formed between the earth plane 35 of said board and a thin layer of conductive material having a dielectric disposed therebetween. Typical values of the capacitance of said capacitor are in the order of magnitude of some 10 pF. Assuming the use of a flat capacitor, dimensioning of the capacitor surfaces is determined essentially by the frequency of the signals; more specifically the edge length of the capacitor must be smaller than one-eighth of the wavelength of the signals. In order to obtain the aforesaid small capacitance values, the distance between the capacitor plates will be only a few micrometers. Thus, when producing a buried capacitor, e.g. when mounting a chip on a printed circuit board, it is difficult to place one surface 36 of the capacitor in a manner such as to enable a minimum distance in the order of some micrometers to be obtained between said surface 36 and the earth plane. When using the inventive dielectric material and the capacitor surface 36 is pressed against the earth plane 35, the diameter of the particles prevent the thickness from falling beneath the minimum distance corresponding to the diameter of the particles. Thus, with the aid of the inventive dielectric material, a thin dielectric layer can be readily applied to a buried capacitor without increasing the risk of a short circuit.

It will be understood that the invention is not restricted to the aforedescribed and illustrated exemplifying embodiments thereof, and that modifications can be made within the scope of the accompanying claims.

1. Material intended for application between two planar electrically conductive layers, wherein said material has dielectric properties and is doped with a concentration from a range extending between 5% and 15% of non-conductive particles, which have a thickness from a range of between 5 μm and 20 μm, in order to obtain a distance-retaining effect between said layers as a result of pressing said layers together.

2. The material according to claim 1, wherein the particles are spherical.

3. The material according to claim 1, wherein the particles are in the form of flakes.

4. The material according to claim 1, wherein the particles are comprised of ceramic powder.

5. The material according to claim 1, wherein the dielectric material has a high viscosity.

6. The material according to claim 1, wherein the dielectric material has adhesive properties.

7. The material according to claim 1, wherein the dielectric material is sufficiently soft at the laminating temperature to enable an object to enter the material, but which will harden at typical operating temperatures, and wherein the nature of the particles is such as to prevent said particles from deforming at said temperatures, providing that normal pressure conditions prevail.

8. The material according to claim 1, wherein the dielectric material is comprised of thermosetting resin.

9. A method of producing a structure that consists of a first and a second layer of a conductive material with a layer of dielectric material therebetween, comprising
applying to the first conductive layer a dielectric material that has been doped with nonconductive particles to a given concentration;
pressing the second layer into the dielectric material or allowing said second layer to sink into said dielectric material in a manner such that the particles embedded in the dielectric material will hold the second layer at a minimum distance from the first layer.

10. The use of a dielectric material according to claim 1 between two layers in order to achieve a distance-retaining effect when pressing said layers together.
